(19) United States
(12) Patent Application Publication
(10) Pub. No.: US 2020/0057972 A1
(43) Pub. Date: Feb. 20, 2020

(54) SYSTEM AND METHOD FOR MANAGEMENT OF PROJECT PORTFOLIOS

(71) Applicant: ELBIT SYSTEMS LTD., Haifa (IL)

(72) Inventors: Shiran RENFORD, Haifa (IL); Michal YOHAI, Haifa (IL)

(21) Appl. No.: 16/559,679

(22) Filed: Sep. 4, 2019

Related U.S. Application Data
(63) Continuation of application No. 16/490,910.

(30) Foreign Application Priority Data
Jun. 4, 2018 (IL) 259815

(51) Int. Cl. G06Q 10/06

(52) U.S. Cl. CPC G06Q 10/06313; G06Q 10/06314

(57) ABSTRACT

A system for management of one or more projects developed by a one or more teams, each project of the projects spans over a plurality of consecutive time-periods, and having a plurality of milestones, each milestone having a milestone due-date, the system comprising a processing resource configured to perform the following for at least one given project of the projects: obtain information of a plurality of features required for completion of the given project, wherein each feature of the features (a) is associated with a functionality that delivers business value to a client of the given project, (b) has a feature size, the feature size being indicative of a complexity of the feature, (c) is associated with a given team of the teams; and (d) is associated with a given milestone of the milestones of the given project, so that a feature completion date of the feature affects an ability to meet the milestone due-date of the given milestone; determine, for each of the features, a feature completion date, based on the feature size, and a velocity of the given team, wherein the velocity is indicative of the given team's capacity, and wherein the velocity is determined based on past performance of the given team; and generate one or more project execution plans, defining an order of execution of the features, for the at least one given project based on the feature completion dates.

### TECHNICAL FIELD

The invention relates to a system and method for management of hybrid projects and project portfolios.

### BACKGROUND

More and more organizations choose agile development methodologies for their project development process. Agile methodologies are development methods and tools that value iterative, incremental and evolutionary processes. Efficient and face-to-face communication techniques are preferred and very short feedback loops and adaptation cycles with a focus on quality are a desired goal. Agile methods and tools are designed to embrace changes into the project development process.

Agile methodologies define the basic work chunk a team works on as a feature. The feature is associated with a functionality that delivers business value to a client of a given project. Each team has a backlog of features deriving from one or more projects the team is working on. In each iteration of work, wherein an iteration is a time-period, where the teams deliver incremental value, the team works on one or more features. The team usually plans ahead for the next few iterations only (e.g. for the next two to four iterations), and the features that are not completed as planned are deferred to future iterations.

Classical Project managements methods and tools are focused in initiating, planning, executing and controlling development projects in order for those projects to be on-time, on-budget and on-quality. Project managements methods are focused on deliveries and are customer driven and are based on long term plans, with identified external constraints.

These classical project management values are missing from agile methodologies, which embrace change at the team level, but lack the tools to measure the effect of these changes on the overall project and project portfolio levels.

There is thus a need to create hybrid project and project portfolios management methods and tools that can incorporate agile processes and values while providing the tools required for on-time delivery of the projects and their milestones to the clients.

One example of an agile methodology implementation is the Scaled Agile Framework (SAFe). SAFe is a framework intended to support scaling of agile methodologies across enterprises. The SAFe methodology, and other agile methodologies, are missing the project level, thus updates made at the team level to the team work plan are not reflected at the project level workplan and are not reflected in the context of a project portfolio workplan.

Additional classical project management tools are absent when working with agile methodologies—project plan simulation, project plan optimization, team structure recommendations, task assignments recommendations, budget planning, earned value planning, business value determination and more. These management tools may be re-introduced when using a hybrid project and project portfolio management system and method.

There is thus a need in the art for a new system and method for management of hybrid projects and project portfolios.

References considered to be relevant as background to the presently disclosed subject matter are listed below. Acknowledgement of the references herein is not to be inferred as meaning that these are in any way relevant to the patentability of the presently disclosed subject matter.

Grey, J., 2011. The development of a hybrid agile project management methodology (Doctoral dissertation, North-West University), disclosed a study investigating whether a combination of agile system development methodologies (ASDMs) and project management methodologies (PMMs) can be used to develop a hybrid APMM that will have the ability to deliver information technology (IT) projects successfully in a constantly changing business and project environment.

US Patent application No. 2017/0161063 (Bishop) published on Jun. 8, 2017, discloses a method for managing product development that includes receiving development data. The method also includes recording an amount of time spent developing one or more project features; calculating, based at least in part on development data and the amount of time spent developing the feature, business momentum; and calculating, based on certain development data, project agility and market agility.

US Patent application No. 2005/0114829 (Robin et al.) published on May 26, 2005, discloses the process of designing and developing a software project is facilitated with one or more of multiple exemplary data structures. These exemplary data structures facilitate interaction among team members from one or more teams selected from those of an exemplary team model and across process phases of two or more process phases selected from those of an exemplary process model. Moreover, the exemplary data structures facilitate implementation of and adherence to (i) an exemplary risk management discipline and process and (ii) an exemplary readiness management discipline and process. These exemplary data structures include, but are not limited to, a milestone review data structure, a team lead project progress data structures, a vision/scope data structure, a project structure data structure, a team member project progress data structure, a master project plan data structure, a training plan data structure, a functional specification data structure, and a post project analysis data structure.

US Patent application No. 2014/0032256 (Hess et al.) published on Jan. 30, 2014, discloses a computer hardware-implemented method, system, and/or computer program product creates an optimized project portfolio. Parameters, which defined constraints on a project portfolio, are established. The project portfolio is populated with a mixture of critical path projects and critical chain projects. The project portfolio is then optimized by: in response to determining that start and finish dates have been committed to project sponsors of in-progress projects within the project portfolio, locking the in-progress projects into place on a portfolio timeline; adjusting expectations for the in-progress projects based on performance to date in order to extend a finish date; combining all other projects, which are not yet committed, in priority order onto the portfolio timeline by mapping each generic timeline onto actual calendar dates; and sliding unanchored projects forward or backward on the portfolio timeline to fill holes and smooth bulges in the portfolio timeline.

U.S. Pat. No. 8,875,088 (Holler et al.) published on Oct. 28, 2014, discloses a computer-implemented method of performing project schedule forecasting based on stored project data includes receiving a first user input selecting a first plurality of work items in a project. Respective work items of the first plurality have respective work estimates. A second user input is received specifying one or more first work item attributes referencing historical work completion data. A first historical rate of work completion is determined in accordance with the historical work completion data referenced by the one or more first work item attributes. An estimated time of completion of the first plurality of work items is calculated in accordance with the first historical rate of work completion and provided for display.

### GENERAL DESCRIPTION

In accordance with a first aspect of the presently disclosed subject matter, there is provided a system for management of one or more projects developed by a one or more teams, each project of the projects spans over a plurality of consecutive time-periods, and having a plurality of milestones, each milestone having a milestone due-date, the system comprising a processing resource configured to perform the following for at least one given project of the projects: obtain information of a plurality of features required for completion of the given project, wherein each feature of the features (a) is associated with a functionality that delivers business value to a client of the given project, (b) has a feature size, the feature size being indicative of a complexity of the feature, (c) is associated with a given team of the teams; and (d) is associated with a given milestone of the milestones of the given project, so that a feature completion date of the feature affects an ability to meet the milestone due-date of the given milestone; determine, for each of the features, a feature completion date, based on the feature size, and a velocity of the given team, wherein the velocity is indicative of the given team's capacity, and wherein the velocity is determined based on past performance of the given team; and generate one or more project execution plans, defining an order of execution of the features, for the at least one given project based on the feature completion dates.

In some cases, the processing resource is further configured to generate, for at least one given team of the teams, one or more team execution plans, defining an order of execution of a plurality of team features, wherein the team features are features associated with the given team and wherein the order of execution is based on the team features completion dates.

In some cases, the processing resource is further configured to perform the following for at least one given team execution plan of the team execution plans: determine Work In Progress (WIP), wherein WIP is indicative of the number of team features having corresponding feature completion dates within a given time-period of a time-period required to execute the given team execution plan; and provide an alert to a user of the system, upon WIP being above a recommended WIP threshold.

In some cases, the processing resource is further configured to perform the following for at least one given team execution plan of the team execution plans: determine a flow interruption probability, based on: (a) the number of associations of the features having corresponding feature completion dates within a given time-period of a time-period required to execute the given team execution plan, (b) over allocation of the corresponding given team within the given time-period, and (c) under allocation of the corresponding given team within the given time-period; and provide an alert to a user of the system, upon the flow interruption probability being above a second threshold.

In some cases, the processing resource is further configured to perform the following for at least one given feature of the features: obtain an indication of an update of the feature completion date of the given feature, giving rise to an updated feature completion date, wherein the feature completion date is before the milestone due-date of the given milestone with which the given feature is associated, and wherein the updated feature completion date is after the milestone due-date of the given milestone with which the given feature is associated; and provide an alert of the update to a user of the system.

In some cases, the processing resource is further configured to update, upon the feature completion date being updated, one or more other feature completion dates, that are on a critical path to the given milestone.

In some cases, the milestones are one or more of the following: contractual milestones defined by a contract with the client; internal milestones defined by a project manager of the project; epic milestones; and objective milestones.

In some cases, each feature of the features is further associated with a business value score indicative of a business value of the feature to the client, and wherein the generate is based also on the business value score.

In some cases, the processing resource is further configured to: determine at least one feature of the features with a corresponding business value score that is below a third threshold, giving raise to Cost Of Poor Execution (COPE) features; and provide an alert of the COPE features to a user of the system.

In some cases, the processing resource is further configured to determine project execution value for each of the project execution plans.

In some cases, the processing resource is further configured to display the project execution plans to a user of the system, ranked according to the project execution value of the project execution plans.

In some cases, the feature size is in feature size units, and wherein each team of the teams is associated with a team cost per feature size unit.

In some cases, the team cost per feature size unit is determined based on historical costs of the given team in a given time-period, divided by a number of feature size units the given team completed during the given time-period.

In some cases, the processing resource is further configured to determine a project execution plan budget for each of the project execution plans, wherein the project execution plan budget is determined using the team cost per feature size. In some cases, the processing resource is further configured to determine an earned value score for a given project, wherein the earned value score is determined based on: (a) the one or more project execution plans of the given project, (b) on the respective project execution plan budgets of the given project, and (c) on an historical project execution plan of the given project.

In some cases, at least part of the features are associated with corresponding priority scores, and wherein the generate is also based on the priority scores.

In some cases, the processing resource is further configured to generate simulated project execution plans using one or more modified priority scores.

In some cases, the processing resource is further configured to generate simulated project execution plans for simulated projects including one or more additional features or one or more removed features of the features.

In some cases, at least one of the features is associated with one or more of the following additional parameters: (a) business value score, (b) risk level, and (c) required resources, and wherein the processing resource is further configured to perform the generate by optimizing the feature execution order of the at least one given project.

In some cases, the feature execution order is optimized so that project execution plan budgets of the project execution plans are minimized.

In some cases, the feature execution order is optimized so that resources required for the project execution plans are minimized.

In some cases, the feature execution order is optimized to minimize a cost of delay.

In some cases, at least one given team of the teams is associated with a team structure, being inductive of the resources available to the given team and wherein the feature execution order is optimized to best utilize the given team's resources.

In some cases, each feature is associated with required resources, each team has team resources, and wherein the processing resource is further configured to assign the features to the teams based on the feature's required resources and the team's team resources.

In some cases, each team is associated with a team history indicative of past features developed by the team, and wherein the processing resource is further configured to assign the features to the teams based on the team's history.

In some cases, each of the features is associated with a feature type.

In some cases, the processing resource is further configured to recommend a team structure for one or more of the features based on the feature type and on historical information of structures of teams experienced with completing historical features of the feature type.

In accordance with a second aspect of the presently disclosed subject matter, there is provided a method for management of one or more projects developed by a one or more teams, each project of the projects spans over a plurality of consecutive time-periods, and having a plurality of milestones, each milestone having a milestone due-date, the method comprising performing the following for at least one given project of the projects: obtaining, utilizing a processing resource, information of a plurality of features required for completion of the given project, wherein each feature of the features (a) is associated with a functionality that delivers business value to a client of the given project, (b) has a feature size, the feature size being indicative of a complexity of the feature, (c) is associated with a given team of the teams; and (d) is associated with a given milestone of the milestones of the given project, so that a feature completion date of the feature affects an ability to meet the milestone due-date of the given milestone; determining, utilizing the processing resource, for each of the features, a feature completion date, based on the feature size, and a velocity of the given team, wherein the velocity is indicative of the given team's capacity, and wherein the velocity is determined based on past performance of the given team; and generating, utilizing the processing resource, one or more project execution plans, defining an order of execution of the features, for the at least one given project based on the feature completion dates.

In some cases, the method, further comprising generating, utilizing the processing resource, for at least one given team of the teams, one or more team execution plans, defining an order of execution of a plurality of team features, wherein the team features are features associated with the given team and wherein the order of execution is based on the team features completion dates.

In some cases, the method further comprising performing the following for at least one given team execution plan of the team execution plans: determining, utilizing the processing resource, Work In Progress (WIP), wherein WIP is indicative of the number of team features having corresponding feature completion dates within a given time-period of a time-period required to execute the given team execution plan; and providing, utilizing the processing resource, an alert to a user of the system, upon WIP being above a recommended WIP threshold.

In some cases, the method further comprising performing the following for at least one given team execution plan of the team execution plans: determining, utilizing the processing resource, a flow interruption probability, based on: (a) the number of associations of the features having corresponding feature completion dates within a given time-period of a time-period required to execute the given team execution plan, (b) over allocation of the corresponding given team within the given time-period, and (c) under allocation of the corresponding given team within the given time-period; and providing, utilizing the processing resource, an alert to a user of the system, upon the flow interruption probability being above a second threshold.

In some cases, the method further comprising performing the following for at least one given feature of the features: obtaining, utilizing the processing resource, an indication of an update of the feature completion date of the given feature, giving rise to an updated feature completion date, wherein the feature completion date is before the milestone due-date of the given milestone with which the given feature is associated, and wherein the updated feature completion date is after the milestone due-date of the given milestone with which the given feature is associated; and providing, utilizing the processing resource, an alert of the update to a user of the system.

In some cases, the method further comprising updating, utilizing the processing resource, upon the feature completion date being updated, one or more other feature completion dates, that are on a critical path to the given milestone.

In some cases, the milestones are one or more of the following: contractual milestones defined by a contract with the client; internal milestones defined by a project manager of the project; epic milestones; and objective milestones.

In some cases, each feature of the features is further associated with a business value score indicative of a business value of the feature to the client, and wherein the generating is based also on the business value score.

In some cases, the method further comprising determining, utilizing the processing resource, at least one feature of the features with a corresponding business value score that is below a third threshold, giving raise to Cost Of Poor Execution (COPE) features; and providing, utilizing the processing resource, an alert of the COPE features to a user of the system.

In some cases, the method further comprising determining, utilizing the processing resource, a project execution value for each of the project execution plans.

In some cases, the method further comprising displaying, utilizing the processing resource, the project execution plans to a user of the system, ranked according to the project execution value of the project execution plans.

In some cases, the feature size is in feature size units, and wherein each team of the teams is associated with a team cost per feature size unit.

In some cases, the team cost per feature size unit is determined based on historical costs of the given team in a given time-period, divided by a number of feature size units the given team completed during the given time-period.

In some cases, the method further comprising determining, utilizing the processing resource, a project execution plan budget for each of the project execution plans, wherein the project execution plan budget is determined using the team cost per feature size.

In some cases, the method further comprising determining, utilizing the processing resource, an earned value score for a given project, wherein the earned value score is determined based on: (a) the one or more project execution plans of the given project, (b) on the respective project execution plan budgets of the given project, and (c) on an historical project execution plan of the given project.

In some cases, at least part of the features are associated with corresponding priority scores, and wherein the generating is also based on the priority scores.

In some cases, the method further comprising generating, utilizing the processing resource, simulated project execution plans using one or more modified priority scores.

In some cases, the method further comprising generating, utilizing the processing resource, simulated project execution plans for simulated projects including one or more additional features or one or more removed features of the features.

In some cases, at least one of the features is associated with one or more of the following additional parameters: (a) business value score, (b) risk level, and (c) required resources, and wherein the method further comprising performing the generating, utilizing the processing resource, by optimizing the feature execution order of the at least one given project.

In some cases, the feature execution order is optimized so that project execution plan budgets of the project execution plans are minimized.

In some cases, the feature execution order is optimized so that resources required for the project execution plans are minimized.

In some cases, the feature execution order is optimized to minimize a cost of delay.

In some cases, at least one given team of the teams is associated with a team structure, being inductive of the resources available to the given team and wherein the feature execution order is optimized to best utilize the given team's resources.

In some cases, each feature is associated with required resources, each team has team resources, and wherein the method further comprising assigning, utilizing the processing resource, the features to the teams based on the feature's required resources and the team's team resources.

In some cases, each team is associated with a team history indicative of past features developed by the team, and wherein the method further comprising assigning, utilizing the processing resource, the features to the teams based on the team's history.

In some cases, each of the features is associated with a feature type.

In some cases, the method further comprising recommending, utilizing the processing resource, a team structure for one or more of the features based on the feature type and on historical information of structures of teams experienced with completing historical features of the feature type.

In accordance with a second aspect of the presently disclosed subject matter, there is provided a non-transitory computer readable storage medium having computer readable program code embodied therewith, the computer readable program code, executable by at least one processor of a computer to perform a method for management of one or more projects developed by a one or more teams, each project of the projects spans over a plurality of consecutive time-periods, and having a plurality of milestones, each milestone having a milestone due-date, the method comprising performing the following for at least one given project of the projects: obtaining, utilizing a processing resource, information of a plurality of features required for completion of the given project, wherein each feature of the features (a) is associated with a functionality that delivers business value to a client of the given project, (b) has a feature size, the feature size being indicative of a complexity of the feature, (c) is associated with a given team of the teams: and (d) is associated with a given milestone of the milestones of the given project, so that a feature completion date of the feature affects an ability to meet the milestone due-date of the given milestone; determining, utilizing the processing resource, for each of the features, a feature completion date, based on the feature size, and a velocity of the given team, wherein the velocity is indicative of the given team's capacity, and wherein the velocity is determined based on past performance of the given team; and generating, utilizing the processing resource, one or more project execution plans, defining an order of execution of the features, for the at least one given project based on the feature completion dates.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of a project management approach for an agile project, in accordance with the prior art;

FIG. 2 is a schematic illustration of a project plan for a hybrid project, in accordance with the presently disclosed subject matter;

FIG. 3 is a block diagram schematically illustrating one example of a system for management of hybrid projects and project portfolios, in accordance with the presently disclosed subject matter;

FIG. 4 is a flowchart illustrating one example of a sequence of operations carried out for generating one or more project execution plans, in accordance with the presently disclosed subject matter;

FIG. 5 is a flowchart illustrating one example of a sequence of operations carried out for generating one or more team execution plans, in accordance with the presently disclosed subject matter;

FIG. 6 is a flowchart illustrating one example of a sequence of operations carried out for determining Work In Progress (WIP), in accordance with the presently disclosed subject matter;

FIG. 7 is a flowchart illustrating one example of a sequence of operations carried out for determining a flow interruption probability, in accordance with the presently disclosed subject matter;

FIG. 8 is a flowchart illustrating one example of a sequence of operations carried out for managing updates of feature completion dates, in accordance with the presently disclosed subject matter;

FIG. 9 is a flowchart illustrating one example of a sequence of operations carried out for identifying Cost of Poor Execution (COPE) features, in accordance with the presently disclosed subject matter;

FIG. 10 is a flowchart illustrating one example of a sequence of operations carried out for ranking project execution plans according to project execution value, in accordance with the presently disclosed subject matter;

FIG. 11 is a flowchart illustrating one example of a sequence of operations carried out for determining project execution plans budgets, in accordance with the presently disclosed subject matter;

FIG. 12 is a flowchart illustrating one example of a sequence of operations carried out for generating simulated project execution plans, in accordance with the presently disclosed subject matter;

FIG. 13 is a flowchart illustrating one example of a sequence of operations carried out for optimizing project execution plans, in accordance with the presently disclosed subject matter;

FIG. 14 is a flowchart illustrating one example of a sequence of operations carried out for assigning features to teams, in accordance with the presently disclosed subject matter; and

FIG. 15 is a flowchart illustrating one example of a sequence of operations carried out for recommending team structures, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing tern's such as “determining”, “updating”, “recommending”, “assigning”, “generating”, “providing”, “displaying” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

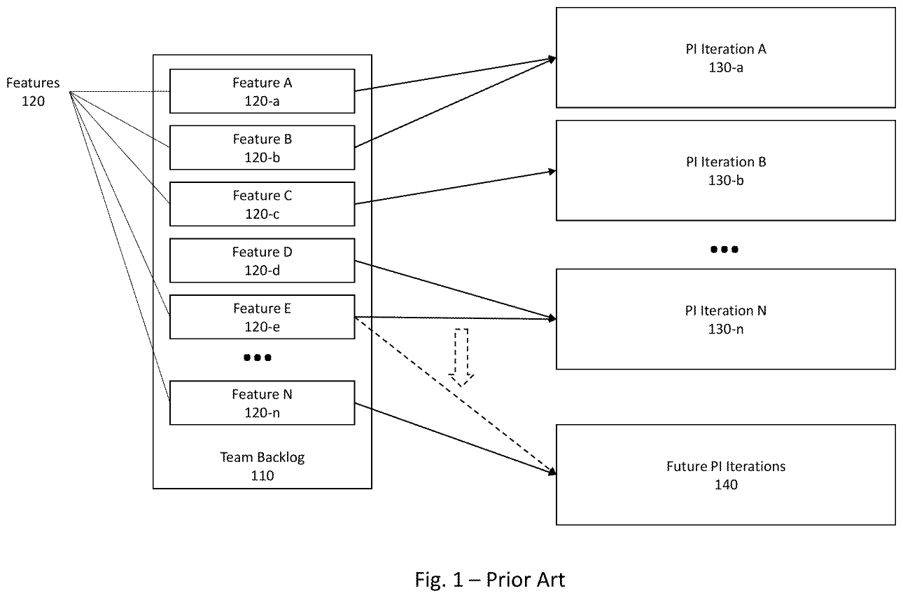

In embodiments of the presently disclosed subject matter, fewer, more and/or different stages than those shown in FIGS. 4-15 may be executed. In embodiments of the presently disclosed subject matter one or more stages illustrated in FIGS. 4-15 may be executed in a different order and/or one or more groups of stages may be executed simultaneously. FIGS. 1-3 illustrate a general schematic of the system architecture in accordance with an embodiment of the presently disclosed subject matter. Each module in FIGS. 1-3 can be made up of any combination of software, hardware and/or firmware that performs the functions as defined and explained herein. The modules in FIGS. 1-3 may be centralized in one location or dispersed over more than one location. In other embodiments of the presently disclosed subject matter, the system may comprise fewer, more, and/or different modules than those shown in FIGS. 1-3.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a schematic illustration of a project management approach for an agile project, in accordance with the prior art.

Agile development methodologies (e.g. Scrum, Kanban, Large-scale Scrum (LeSS), SAFe, etc.), known in the art, define the basic work chunks a development team works on as features 120 (e.g. feature A 120-a, feature B 120-b, feature C 120-c, feature D 120-d, feature E 120-e, . . . , feature N 120-n). Each of the features 120 is associated with functionality that delivers business value to a client of a given project. Each agile development team has a team backlog 110 of one or more features 120. The team backlog 110 represents product capabilities the team need to develop. The features 120 in the team backlog 110 may derive from one or more projects the team is working on. As a non-limiting example, team backlog 110 may contain features 120 from a number of projects: feature A 120-a and feature B 120-b may be associated with a first project; Feature C 120-c, feature D 120-d and feature E 120-e may be associated with a second project; Feature N 120-n may be associated with a third project; and so on.

The basic building blocks of an agile development plan are iterations. Iterations are a standard, fixed-length time-period, where the teams deliver incremental value in the form of completed features 120. Please note that iterations may be optionally of different fixed lengths. The duration of the iteration changes between specific implementation of agile methodologies at different organizations, but is usually one to four weeks, depending on the business context.

A Program Increment (PI) is a time-period used for building the agile development plan that includes a number of PI iterations (e.g. PI iteration A 130-a, PI iteration B 130-b, . . . , PI iteration N 130-n). As a non-limiting example, each PI length may be a quarter of a year and each PI may include three to four iterations.

In each PI iteration (e.g. PI iteration A 130-a, PI iteration B 130-b, . . . , PI iteration N 130-n) of work—the team works on one or more of the features 120. The team may plan ahead for the current PI only, and the features 120 that are planned to be completed during the current PI and are not completed as planned are deferred to future PI iterations 140.

An exemplary known method in the art for agile teams to plan their work planning by velocity. Velocity is defined in the art as the number of units of work completed in a certain time-period by the team, wherein the unit to measure velocity is chosen by the team. The unit can either be a real unit like engineer-hours or engineer-days or an abstract unit like relative size of the work or ideal days of effort. Each of the features 120 in the team backlog 110 may be given a size, valued in terms of the chosen unit. The velocity is determined based on past performance of that team, e.g. by dividing the number of units of work completed by the team in a given number of past time-periods by the given number of past time-periods. The velocity is indicative of the team's capacity. Planning by velocity utilizes the team's velocity to assign a reasonable number of features 120 from the team backlog 110 to PI iterations (e.g. PI iteration A 130-a, PI iteration B 130-b, . . . , PI iteration N 130-n) based of the features 120 size and the team's velocity. Features 120 that are not completed within their assigned PI iteration (e.g. PI iteration A 130-a, PI iteration B 130-b, . . . , PI iteration N 130-n) are deferred to future PI iterations 140.

The prior art agile planning methods have a few limitations: the planning is done for the current PI only, and not for the entire duration of the projects which features 120 are associated with, thus the project managers cannot gain an understanding of the efforts required by the teams to complete an entire project or a portfolio of projects. Another limitation is that that the features 120 are not associated (e.g. predecessor constraints, finish-to-start constraints, start-to-start constraints, finish-to-finish constraints, start-to-finish constraints etc.) with other features or with project level milestones. These association constraints determine the order in which activities need to be performed, so that without these association constraints the effect of deferring features 120 to future PI iterations 140 cannot be fully understood and is not reflected in an overall project plan. In a non-limiting example, a given team has a team backlog 100 with features 120. The team plans their work and plans to complete features 120 during the following PI iterations: Feature A 120-a and feature B 120-b are assigned to PI iteration A 130-a. Feature C 120-c is assigned to be completed during PI iteration B 130-b. Feature D 120-d and feature E 120-e are assigned to be completed during PI iteration N 130-n. Feature N 120-n is out of the scope of the team's capability and is assigned to future PI iteration 140. For some reason (e.g. the team did not estimate the size of feature E 120-e correctly, or for other relevant reasons) the team does not complete feature E 120-e during PI iteration N 130-n. Feature E 120-e is then deferred to future PI iterations 140 and may be re-introduced to one of the PI iterations (e.g. PI iteration A 130-a, PI iteration B 130-b, . . . , PI iteration N 130-n) of the team in a future plan.

There is thus a need for a system and method for management of hybrid projects and project portfolios that will reflect the changes in the agile team work plan level at the project and project portfolio work plans level.

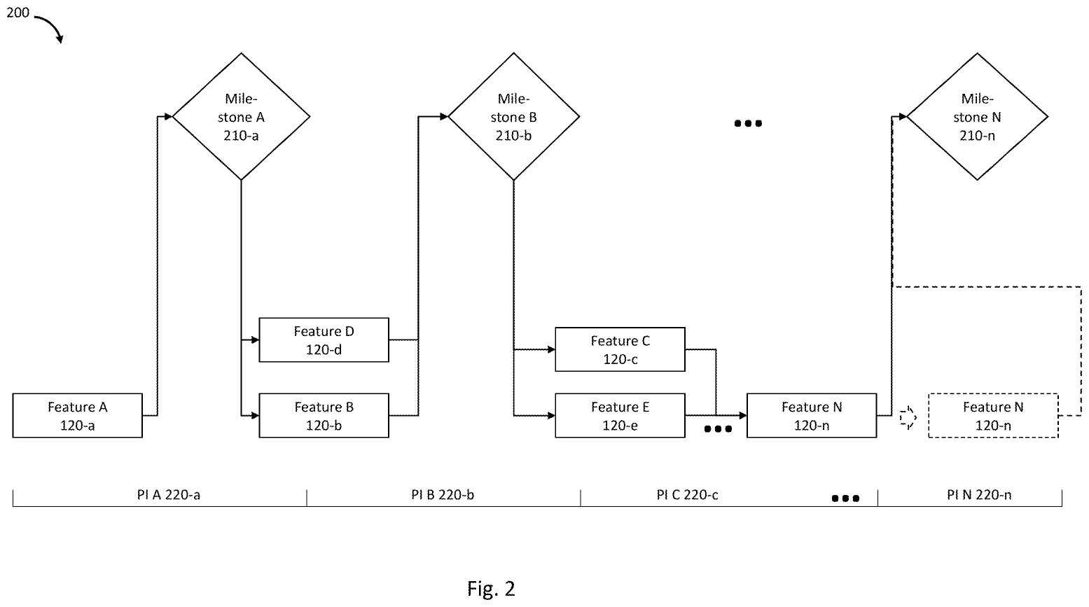

Turning to FIG. 2, there is shown a schematic illustration of a project plan for a hybrid project, in accordance with the presently disclosed subject matter.

According to the presently disclosed subject matter, a hybrid project is a project that incorporate agile processes and values while providing the tools required for on-time delivery of the projects and their milestones to clients of the projects.

As further described herein, a system and method for the management of hybrid projects combines agile methodologies and values together with classical project management methods. This enables connecting agile values and business concerns in a way that supports managing the hybrid project while benefiting from advantages of agile methodologies, while keeping the control level required by project managers to keep their on-time, on-budget and on-quality commitments to the clients of the projects. The hybrid project management system and method described herein also allows agile management of classical projects (e.g. changing work prioritizations by just changing tasks order, etc.).

It is to be noted that the hybrid project management system and method described herein may support a portfolio of more than one project, wherein at least one of the projects in the portfolio is a hybrid project and the projects may be associated with each other in various aspects. The association between the projects may be established by associating a first task in a first project with a second task in a second project.

The described system and method for management of hybrid projects and project portfolios enable saving computational power, and memory utilization by replacing superfluous prior art solutions which require a separate first system to manage the agile part of the hybrid project and a second separate system to handle the project management part of the hybrid project. By assigning these operations to one system, the described invention saves computational power, reduces required storage space and decreases the computational time required for the management of hybrid projects.

Hybrid project plan 200 includes features 120 (e.g. feature A 120-a, feature B 120-b, feature C 120-c, feature D 120-d, feature E 120-e, . . . , feature N 120-n). Each of the features 120 may be associated with a functionality that delivers business value to a client of a given project. Each of the features 120 may have a feature size, being indicative of a complexity of the feature, and each of the features 120 may be associated with a given team responsible for completing the feature. Features 120 encompass the functionality required to be completed for the entire duration of a given project. This is in contrast to prior art agile methodologies, wherein planning is done at the team level for a current Program Increment (PI) only, as detailed above, inter alia with respect to FIG. 1.

In addition, each of the features 120 may be associated (e.g. by predecessor constraints, finish-to-start constraints, start-to-start constraints, finish-to-finish constraints, start-to-finish constraints, etc.) with other features 120 or with one or more project level milestones defined by the Hybrid project plan 200 (milestone A 210-a, milestone B 210-b, . . . , milestone N 210-n). These association constraints determine the order in which the features 120 need to be performed to complete the hybrid project in accordance with the hybrid project plan 200. Each of the milestones (milestone A 210-a, milestone B 210-b, . . . , milestone N 210-n) may be a contractual milestone (defined by a contract with a client of the given project), an internal milestone (defined by a project manager of the given project), an epic milestones (defined as a group of features 120 that are part of a one large body of work or objective milestones defined as a number of features 120 that have one common objective), etc.

Each milestone (e.g. milestone A 210-a, milestone B 210-b, . . . , milestone N 210-n) may have a milestone due-date. The milestone due-date is the deadline date for which the milestone, and all associated predecessors features 120 should be completed. The terms due-date and deadline will be used interchangeably. The project manager of the given project is responsible that the milestone due-dates will be met as planned.

The given project duration spans over a plurality of consecutive time-periods, each time-period is a Program Increment (PI) (e.g. PI A 220-a, PI B 220-b, PI C 220-c, . . . , PI N 220-n). Each PI (e.g. PI A 220-a, PI B 220-b, PI C 220-c, . . . , PI N 220-n) is a time-period used for building the hybrid project plan 200, wherein within each of the PI's its corresponding features 120, and optionally some of the milestones (e.g. milestone A 210-a, milestone B 210-b, . . . , milestone N 210-n) are planned to be completed. As a non-limiting example, each PI length may be a quarter of a year (e.g. January to March, April to June, July to September, October to December).

As indicated herein, inter alia with reference to FIG. 1, each PI (e.g. PI A 220-a, PI B 220-b, PI C 220-c, . . . , PI N 220-n) may include a number of iterations. For example, each PI (e.g. PI A 220-a, PI B 220-b, PI C 220-c, . . . , PI N 220-n) may include three to four iterations.

In some cases, the planning resolution may be different for different PI (e.g. PI A 220-a, PI B 220-b, PI C 220-c, . . . , PI N 220-n). As a non-limiting example, the features 120 having completion dates within the current PI (for example: PI A 220-a) may be planned at the resolution level of iterations within the current PI, meaning that for each of features 120 with completion dates within the current PI—a completion date will be determined inside a specific iteration of the current PI. Features 120 with completion dates within one of the future PI, subsequent to the current PI (for example PI C 220-c), may be planned at the resolution level of the entire PI, meaning that the completion dates will be determined to be at the end of the PI C 220-c or determined to be at a specific milestone (e.g. milestone A 210-a, milestone B 210-b, . . . , milestone N 210-n) within the current PI.

The completion date of each of features 120 may be determined based on the feature's (e.g. feature A 120-a, feature B 120-b, feature C 120-c, feature D 120-d, feature E 120-e, . . . , feature N 120-n) size, and a velocity of a given team, with which the feature (e.g. feature A 120-a, feature B 120-b, feature C 120-c, feature D 120-d, feature E 120-e, . . . , feature N 120-n) is associated.

The velocity of a given team is indicative of the given team's capacity, and it can be determined based on past performance of the given team. The duration may be determined for each of the features 120 by dividing the corresponding features' 120 size with the given team's velocity. The duration of each of the features 120 may be then utilized to determine the features' 120 completion dates.

As a non-limiting example, feature's A 120-a size can be 10 units and it can be associated with a first team. The first team's velocity can be 100 units per PI (e.g. PI A 220-a, PI B 220-b, PI C 220-c, . . . , PI N 220-n), based on the actual past performance of the first team. The duration of feature A 120-a in this example will be one tenth of the duration of a PI (e.g. PI A 220-a, PI B 220-b, PI C 220-c, . . . , PI N 220-n). The completion date of feature A 120-a may be set, in this example, to end at the end of a duration that is one tenth of the duration of the PI (e.g. PI A 220-a, PI B 220-b, PI C 220-c, . . . , PI N 220-n), wherein the start date of feature A 120-a may be set in accordance to the associations feature A 120-a has with other features 120 and other milestones (e.g. milestone A 210-a, milestone B 210-b, . . . , milestone N 210-n).

In accordance with another example, the features 120 completion dates may be set in accordance with the PI (e.g. PI A 220-a, PI B 220-b, PI C 220-c, . . . , PI N 220-n) or in accordance with an iteration within a PI (e.g. PI A 220-a, PI B 220-b, PI C 220-c, . . . , PI N 220-n) that the specific feature (e.g. feature A 120-a, feature B 120-b, feature C 120-c, feature D 120-d, feature E 120-e, . . . , feature N 120-n) is associated with. In this embodiment, the completion date will be set to be the last date of the PI (e.g. PI A 220-a, PI B 220-b, PI C 220-c, . . . , PI N 220-n) or the last date of the iteration within the PI PI A 220-a, PI B 220-b, PI C 220-c, . . . , PI N 220-n).

In accordance with an additional example, the feature's (e.g. feature A 120-a, feature B 120-b, feature C 120-c, feature D 120-d, feature E 120-e, . . . , feature N 120-n) duration may also be determined based on a team factor of the given team. The team factor is based on the actual capability of the team. As a non-limiting example, a team with missing resources will have a factor smaller than one. A team with excess resources will have a factor higher than one.

In some cases, an update to a given feature (e.g. feature A 120-a, feature B 120-b, feature C 120-c, feature D 120-d, feature E 120-e, . . . , feature N 120-n) completion date may affect the ability to meet a milestone (e.g. milestone A 210-a, milestone B 210-b, . . . , milestone N 210-n) due-date of the milestone with which the given feature (e.g. feature A 120-a, feature B 120-b, feature C 120-c, feature D 120-d, feature E 120-e, . . . , feature N 120-n) is associated.

The hybrid project plan 200 described herein, enables planning features 120 for the entire duration of the project and supports reflecting the influence of changes to the features 120 completion dates upon the project's millstones (e.g. milestone A 210-a, milestone B 210-b , . . . , milestone N 210-n).

Hybrid project plan 200 illustrates an exemplary hybrid project plan wherein features 120 are associated with other features 120 and optionally with milestones (e.g. milestone A 210-a, milestone B 210-b, . . . , milestone N 210-n). The project spans over a number of PIs (e.g. PI A 220-a, PI B 220-b, PI C 220-c, . . . , PI N 220-n). In this example milestone N 210-n is associated with feature N 120-n (among others). Feature N 120-n completion date is before milestone N 210-n due-date. A change is made to the completion date of feature N 120-n, either directly or indirectly due to a change in the completion dates of other features 120 that feature N 120-n depends upon, so that the updated completion date of feature N 120-n is after milestone's N 210-n due date. This may cause milestone's N 210-n due date not to be met.

In such cases, an alert of an update that a change to a feature completion date results in a milestone due-date not being met can be provided to a user of the system (e.g. to the program manager of the hybrid project).

As explained above, the described system and method may be applied, mutatis mutandis, to a project portfolio, wherein at least one of the projects in the portfolio is a hybrid project and the projects may be associated with each other in various aspects. The association between the projects may be by an association between a first feature in a first project and second feature in a second project.

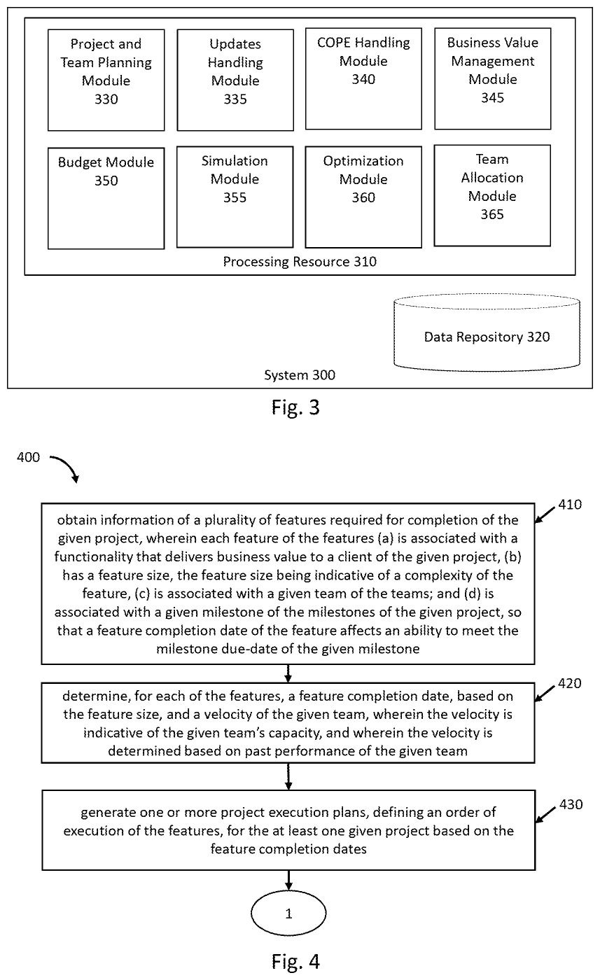

Attention is drawn to FIG. 3, there is shown a block diagram schematically illustrating one example of a system for management of hybrid projects and project portfolios, in accordance with the presently disclosed subject matter.

According to certain examples of the presently disclosed subject matter, system 300 can comprise, or be otherwise associated with, a data repository 320 (e.g. a database, a storage system, a memory including Read Only Memory—ROM, Random Access Memory—RAM, or any other type of memory, etc.) configured to store data, including inter alia one or more features 120 including metadata thereof (e.g. completion dates, feature sizes, features associations, features types, teams historical performance, etc.), milestones 210 including metadata thereof (e.g. milestones 210 due-dates, etc.), project execution plans, team execution plans, etc. Data repository 320 can be further configured to enable retrieval and/or update and/or deletion of the stored data. It is to be noted that in some cases, data repository 320 can be distributed, while the system 300 has access to the information stored thereon, e.g. via a computer network.

System 300 further comprises one or more processing resource 310. Processing resource 310 can be one or more processing units (e.g. central processing units), microprocessors, microcontrollers or any other computing devices or modules, including multiple and/or parallel and/or distributed processing units, which are adapted to independently or cooperatively process data for controlling relevant resources of the system 300 and for enabling operations related to resources of the system 300.

The processing resource 310 can comprise one or more of the following modules: project and team planning module 330, updates handling module 335, COPE handling module 340, business value management module 345, budget module 350, simulation module 355, optimization module 360 and team allocation module 365.

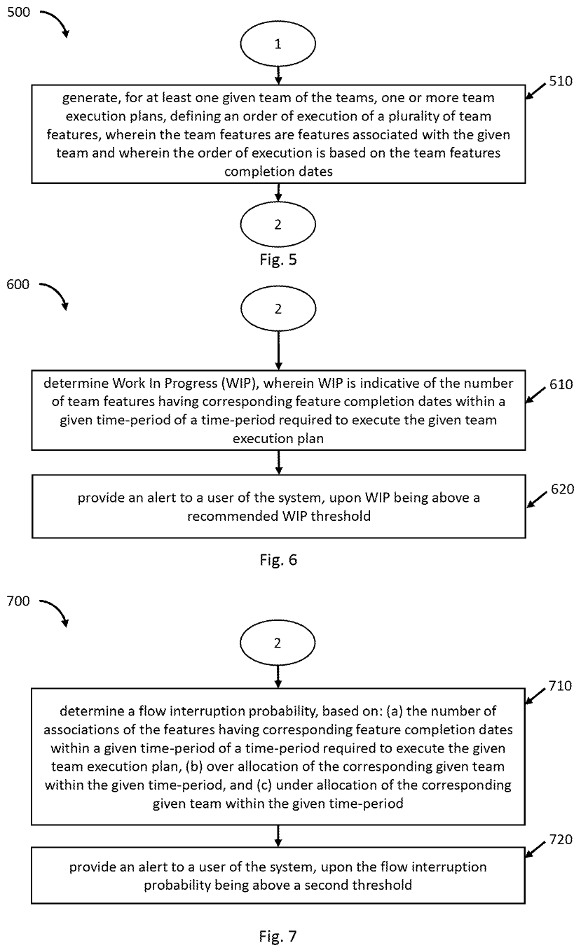

According to some examples of the presently disclosed subject matter, project and team planning module 330 can be configured to perform a project planning process, as further detailed herein, inter alia with respect to FIG. 4. The project and team planning module 330 may be further configured to perform a team planning process, as further detailed herein, inter alia with respect to FIG. 5. The project and team planning module 330 may be further configured to perform a WIP determination process, as further detailed herein, inter alia with respect to FIG. 6. The project and team planning module 330 may be further configured to perform a flow interruption determination process, as further detailed herein, inter alia with respect to FIG. 7.

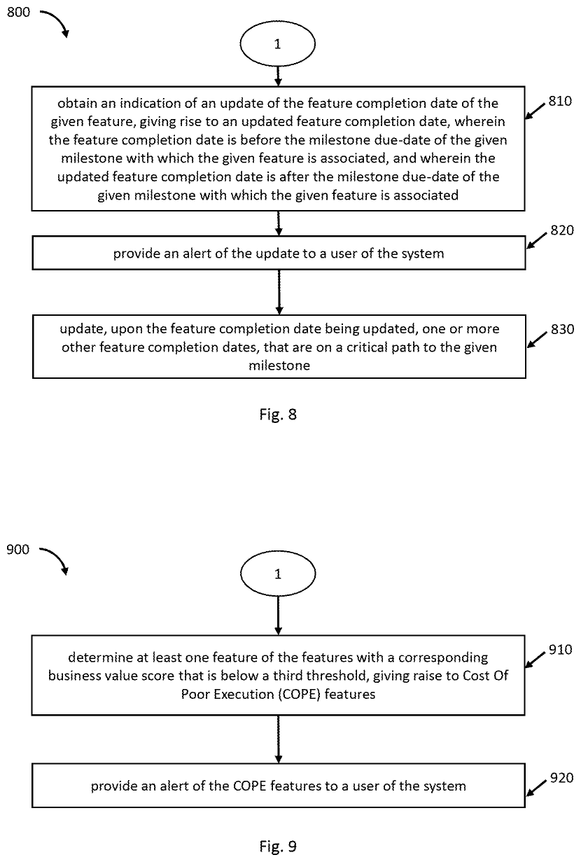

According to some examples of the presently disclosed subject matter, the updates handling module 335 can be configured to perform a plan update process, as further detailed herein, inter alia with respect to FIG. 8.

According to some examples of the presently disclosed subject matter, the COPE handling module 340 can be configured to perform a COPE determination process, as further detailed herein, inter alia with respect to FIG. 9.

According to some examples of the presently disclosed subject matter, the business value management module 345 can be configured to perform a project execution value determination process, as further detailed herein, inter alia with respect to FIG. 10.

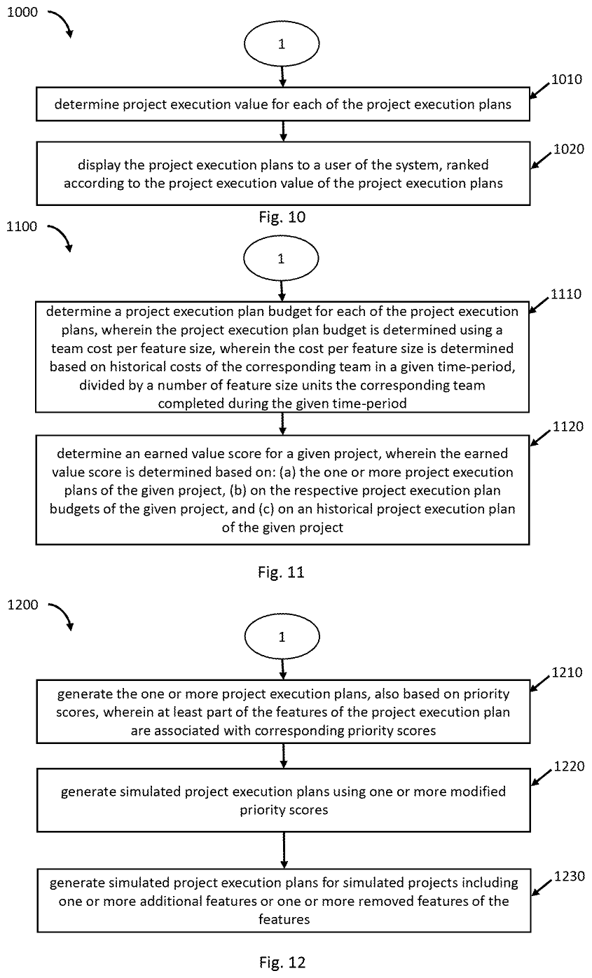

According to some examples of the presently disclosed subject matter, the budget module 350 can be configured to perform a budget and earned value determination process, as further detailed herein, inter alia with respect to FIG. 11.

According to some examples of the presently disclosed subject matter, the simulation module 355 can be configured to perform a simulation process, as further detailed herein, inter alia with respect to FIG. 12.

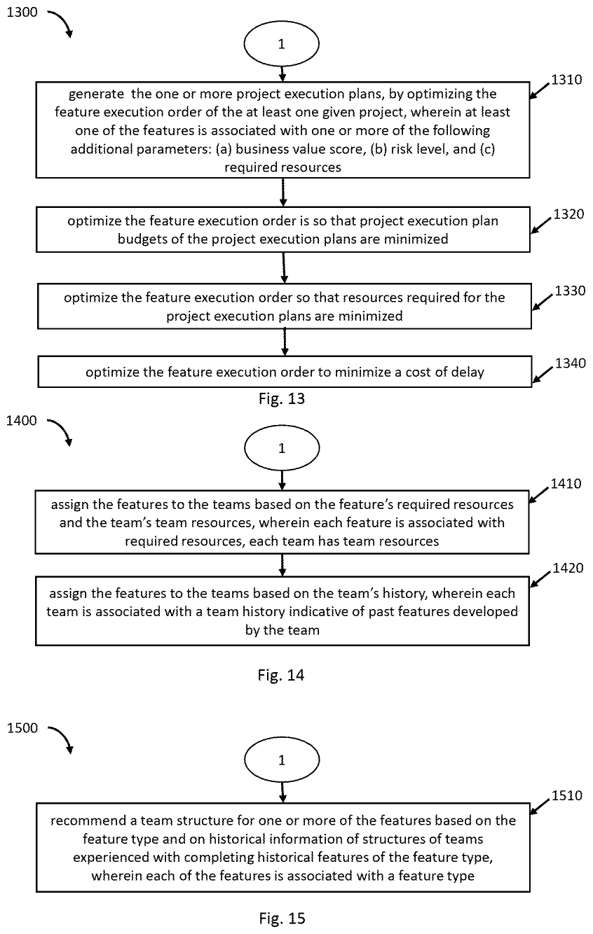

According to some examples of the presently disclosed subject matter, the optimization module 360 can be configured to perform an optimization process, as further detailed herein, inter alia with respect to FIG. 13.

According to some examples of the presently disclosed subject matter, the team allocation module 365 can be configured to perform a team assignment process, as further detailed herein, inter alia with respect to FIG. 14.

According to some examples of the presently disclosed subject matter, the team allocation module 365 may be further configured to perform a team structure recommendation process, as further detailed herein, inter alia with respect to FIG. 15.

Turning to FIG. 4, there is shown a flowchart illustrating one example of a sequence of operations carried out for generating one or more project execution plans, in accordance with the presently disclosed subject matter.

In this embodiment, system 300 may manage one or more projects developed by a one or more teams. In some cases, at least one, and in some cases each, of the projects can span over a plurality of consecutive time-periods. In some cases, at least one, and in some cases each, of the projects can have a plurality of milestones (e.g. milestone A 210-a, milestone B 210-b, . . . , milestone N 210-n) defined by a client of the respective project, each milestone defining corresponding stages of the respective project, and each having a milestone due-date. In some cases, the due-date may be a contractual commitment defined by a contract with the client of the corresponding project. In other cases, the milestone can be derived from other commitments, or from it can be determined by a project manager (arbitrarily, or in accordance with certain rules, etc.).

In some case, the client of the respective project can be an external client, external to an organization developing and/or managing the respective project. In other cases, the client can be an internal client, which is part of the organization developing and/or managing the respective project.

It is noted that the projects may be part of a project portfolio, having inter-relations between at least two of the projects in the project portfolio.

According to certain examples of the presently disclosed subject matter, system 300 can be configured to perform a project planning process 400 for a given project, e.g. utilizing project and team planning module 330.

For this purpose, system 300 can be configured to obtain information of a plurality of features 120 required for completion of the given project (block 410), wherein the information is provided by a user of the system via a user interface, and wherein each of the features 120:

(a) provides a usable functionality that delivers business value to a client of the given project;

(b) has a feature size indicative of a complexity of the feature (e.g. feature A 120-a, feature B 120-b, feature C 120-c, feature D 120-d, feature E 120-e, . . . , feature N 120-n);

(c) is associated with a given team of the teams; and

(d) is associated with a given milestone (e.g. milestone A 210-a, milestone B 210-b, . . . , milestone N 210-n) of the given project, so that a feature completion date of the feature (e.g. feature A 120-a, feature B 120-b, feature C 120-c, feature D 120-d, feature E 120-e, . . . , feature N 120-n) affects an ability to meet the milestone due-date of the given milestone (e.g. milestone A 210-a, milestone B 210-b, . . . , milestone N 210-n).

System 300 may be further configured to determine, for each of the features 120, for each of the projects, a feature completion date, based on the feature size, a velocity of the given team with which the corresponding feature is associated, and the milestones of the projects. Such velocity is indicative of the given team's capacity, and it can be determined based on past performance of the given team (block 420).

As a non-limiting example, feature's A 120-a size is ten (10) units and it is associated with a first team. The first team's velocity is one hundred (100) units per a given time-period, based on the actual past performance of the first team (as determined, e.g. by analysis of information stored on the data repository 320). The duration of feature A 120-a in this example may be one tenth of the duration of the given time-period. The completion date of feature A 120-a may be set, in this example, to end at the end of a duration that is one tenth of the duration of the given time-period, wherein the start date of feature A 120-a may be set in accordance to the associations feature A 120-a has with other features 120 and other milestones (e.g. milestone A 210-a, milestone B 210-b, . . . , milestone N 210-n). In another example, the features 120 completion dates may be set in accordance with the entire time-period or part of the time-period that the specific feature (e.g. feature A 120-a, feature B 120-b, feature C 120-c, feature D 120-d, feature E 120-e, . . . , feature N 120-n) is associated with.

System 300 may be further configured to generate one or more project execution plans, defining an order of execution of the features 120, for the at least one given project based on the feature completion dates determined at block 420. As a non-limiting example, the project execution plan may be visualized by a GANTT chart (block 430).

The project planning process 400 can be executed for a plurality of projects in a given project portfolio comprising more than one project, and in some cases, for each project in the given project portfolio.

System 300 may be further configured to receive, via the user interface, from the user of the system, an update to the feature completion date of one or more of the features of one or more of the projects. Upon the update affecting one or more of the milestones due-dates in one or more of the projects, the system can be configured to repeat blocks 420 and 430.

It is to be noted that in some cases, at least of the teams is a multidisciplinary team, having at least a first team member of a first discipline and at least a second team member of a second discipline other than the first discipline. In some cases, such multidisciplinary team can be assigned to at least one of the features of at least one of the projects.

It is to be noted that, with reference to FIG. 4, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

FIG. 5 is a flowchart illustrating one example of a sequence of operations carried out for generating one or more team execution plans, in accordance with the presently disclosed subject matter.

According to certain examples of the presently disclosed subject matter, system 300 can be configured to perform a team planning process 500, e.g. utilizing project and team planning module 330. It is to be noted that system 300 performs the team planning process 500 after preforming the project planning process 400, as detailed above, inter alia, with respect to FIG. 4. It may be further noted that block 430 may be optional while performing the team planning process 500.

For this purpose, system 300 can be configured to generate, for at least one given team of the teams, one or more team execution plans, defining an order of execution of a plurality of features 120 associated with the given team (also referred to herein as “team features”) (block 510). The order of execution of the team features can be determined based on the team features completion dates. As a non-limiting example, team X may be

associated with feature A 120-a and feature B 120-b. Feature B 120-b is associated with feature A 120-a so that working on feature B 120-b and on feature A 120-a in parallel is not allowed or is limited due to a recommended Work In Progress (WIP) threshold for team X (as detailed below, inter alia, with respect to FIG. 6). The possible team execution plans may be to work on feature A 120-a and then, after its completion, on feature B 120-b, or to work on feature B 120-b and then, after its completion, on feature A 120-a.

It is to be noted that, with reference to FIG. 5, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 6, there is shown a flowchart illustrating one example of a sequence of operations carried out for determining Work In Progress (WIP), in accordance with the presently disclosed subject matter.

According to certain examples of the presently disclosed subject matter, system 300 can be configured to perform a WIP determination process 600, e.g. utilizing project and team planning module 330. It is to be noted that system 300 performs the WIP determination process 600 after preforming the team planning process 500, as detailed above, inter alia, with respect to FIG. 5.

For this purpose, system 300 can be configured to determine WIP, for each team execution plan. WIP is indicative of the number of team features 120 having corresponding feature completion dates within a given time-period of a time-period required to execute the given team execution plan. For example, team X may be determined to be working on five features 120 during a given time period in accordance with a given team execution plan. (block 610).

System 300 may be further configured to provide an alert to a user of the system 300, upon WIP being above a recommended WIP threshold (block 620). Continuing the example of team X, if the recommended WIP threshold is four, an alert will be provided.

As a non-limiting example, the user of the system 300 may be a team manager of the corresponding team and the WIP may be used as a decision support indication for the team manager when choosing which team execution plan to employ.

In addition, WIP may be used to optimize team execution plans, so that the team execution plan is generated in a way that for every given time-period within the team execution plan, the WIP does not exceeds the recommended WIP threshold.

It is to be noted that, with reference to FIG. 6, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Attention is drawn to FIG. 7, is a flowchart illustrating one example of a sequence of operations carried out for determining a flow interruption probability, in accordance with the presently disclosed subject matter.

According to certain examples of the presently disclosed subject matter, system 300 can be configured to perform a flow interruption determination process 700, e.g. utilizing project and team planning module 330. It is to be noted that system 300 performs the flow interruption determination process 700 after preforming the team planning process 500, as detailed above, inter alia, with respect to FIG. 5.

For this purpose, system 300 can be configured to determine a flow interruption probability for each team execution plan (block 710), based on:

(a) the number of associations of the features 120 having corresponding feature completion dates within a given time-period of a time-period required to execute the given team execution plan. The number of features 120 associations may indicate of constraints of a given feature (e.g. feature A 120-a, feature B 120-b, feature C 120-c, feature D 120-d, feature E 120-e, . . . , feature N 120-n) with one or more other features 120, and with one or more milestones (e.g. milestone A 210-a, milestone B 210-b, . . . , milestone N 210-n). A large number of associations may indicate a higher probability of flow interruption for the given feature (e.g. feature A 120-a, feature B 120-b, feature C 120-c, feature D 120-d, feature E 120-e, . . . , feature N 120-n).

(b) over allocation of the corresponding given team within the given time-period (noting that over allocation may be determined based on the velocity of the given team and the amount of feature size units allocated to the team in the team execution plan).

(c) under allocation of the corresponding given team within the given time-period (noting that under allocation may be determined based on the velocity of the given team and the amount of feature size units allocated to the team in the team execution plan). It is to be noted that under allocation may cause non-optimized usage of resources.

(d) lack of resources required to complete a given feature (e.g. feature A 120-a, feature B 120-b, feature C 120-c, feature D 120-d, feature E 120-e, . . . , feature N 120-n). It is to be noted that the required resources may be human resources (such as: professionals, etc.) or physical resources (such as lab, infrastructure, etc.).

System 300 may be further configured to provide an alert to a user of the system, upon the flow interruption probability being above a second threshold (block 720).

For example, the user of the system 300 may be a team manager of the given team and the flow interruption probability may be used as a decision support indicator for the team manager when choosing which team execution plan to employ (e.g. out of a plurality of team execution plans determined at block 510). Another example may be of the team manager, planning the resources available to given team in advance, to eliminate resource bottle necks.

It is to be noted that, with reference to FIG. 7, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 8, there is shown a flowchart illustrating one example of a sequence of operations carried out for managing updates of feature completion dates, in accordance with the presently disclosed subject matter.

According to certain examples of the presently disclosed subject matter, system 300 can be configured to perform a plan update process 800, e.g. utilizing updates handling module 335. It is to be noted that system 300 performs plan update process 800 of a given hybrid project plan (e.g. a given hybrid project plan generated by the project planning process 400, as detailed above, inter alia, with respect to FIG. 4).

For this purpose, system 300 can be configured to obtain an indication of an update of the feature completion date of a given feature (e.g. feature A 120-a, feature B 120-b, feature C 120-c, feature D 120-d, feature E 120-e, . . . , feature N 120-n) of a given project associated with the given hybrid project plan, giving rise to an updated feature completion date. In accordance with the indicated update, the feature completion date, before the update, is before the milestone due-date of a given milestone (e.g. milestone A 210-a, milestone B 210-b, . . . , milestone N 210-n) with which the given feature (e.g. feature A 120-a, feature B 120-b, feature C 120-c, feature D 120-d, feature E 120-e, . . . , feature N 120-n) is associated, and the updated feature completion date, after the update, is after the milestone due-date of the given milestone (e.g. milestone A 210-a, milestone B 210-b, . . . , milestone N 210-n) (block 810).

System 300 may be further configured to provide an alert of the update to a user of the system (block 820). As a non-limiting example, the user of the system 300 is a project manager of a project associated with the corresponding features 120 and the update alert may be used to draw the project manager attention to the possibility of not meeting the given millstone's (e.g. milestone A 210-a, milestone B 210-b, . . . , milestone N 210-n) due-date.

System 300 may be further configured to update, upon the feature completion date being updated, one or more other feature completion dates, that are on a critical path to the given milestone (e.g. milestone A 210-a, milestone B 210-b, . . . , milestone N 210-n). Indirect update to the critical chain of features 120 that leads to the milestone (e.g. milestone A 210-a, milestone B 210-b, . . . , milestone N 210-n) may cause the same effect of not meeting the given milestone's (e.g. milestone A 210-a, milestone B 210-b, . . . , milestone N 210-n) due-date (block 830).

It is noted that the project may be part of a project portfolio.

The plan update process 800 may be applied to project execution plans or to team execution plans mutatis mutandis.

It is to be noted that, with reference to FIG. 8, some of the blocks can be integrated into a consolidated block or can be broken down to a few blocks and/or other blocks may be added. Furthermore, in some cases, the blocks can be performed in a different order than described herein (for example, block 830 can be performed before block 820, etc.). It is to be further noted that some of the blocks are optional. It should be also noted that whilst the flow diagram is described also with reference to the system elements that realizes them, this is by no means binding, and the blocks can be performed by elements other than those described herein.

FIG. 9 is a flowchart illustrating one example of a sequence of operations carried out for identifying Cost of Poor Execution (COPE) features, in accordance with the presently disclosed subject matter.

In this embodiment, each of the features 120 may be further associated with a business value score indicative of a business value of the feature (e.g. feature A 120-a, feature B 120-b, feature C 120-c, feature D 120-d, feature E 120-e, . . . , feature N 120-n) delivered to a client of corresponding project.

According to certain examples of the presently disclosed subject matter, system 300 can be configured to perform a COPE determination process 900, e.g. utilizing COPE handling module 340.

It is to be noted that system 300 performs the COPE determination process 900 after preforming the project planning process 400, as detailed above, inter alia, with respect to FIG. 4, where in block 430 the processing resource 310 is further configured to generate the project execution plans based also on the business value score (e.g. so that the order of execution of the features 120 will be determined so that features 120 with higher business value score will be performed before features 120 with lower business value score).

For this purpose, system 300 can be configured to determine, for at least one feature (e.g. feature A 120-a, feature B 120-b, feature C 120-c, feature D 120-d, feature E 120-e, . . . , feature N 120-n) of the features 120, a corresponding business value score that is below a third threshold, giving raise to COPE features (block 910).

System 300 may be further configured to provide an alert of the COPE features to a user of the system (block 920). The user of the system may be a project manager of the corresponding project or a project portfolio manager that the corresponding project is part thereof.

As a non-limiting example, feature A 120-a and feature B 120-b are each associated with a business value score that is lower than the third threshold. The project manager of the corresponding project may receive an alert of feature A 120-a and feature B 120-b being COPE features. Such COPE features may be postponed to a later stage of the hybrid project plan 200, or can be dropped if required.

It is to be noted that, with reference to FIG. 9, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 10, there is shown a flowchart illustrating one example of a sequence of operations carried out for ranking project execution plans according to project execution value, in accordance with the presently disclosed subject matter.

According to certain examples of the presently disclosed subject matter, system 300 can be configured to perform a project execution value determination process 1000, e.g. utilizing business value management module 345. It is to be noted that system 300 performs the project execution value determination process 1000 after preforming the project planning process 400, as detailed above, inter alia, with respect to FIG. 4.

For this purpose, system 300 can be configured to determine, for each of the project execution plans determined by the project planning process 400, a project execution value (block 1010). The project execution value may be indicative of the business value delivered to a client of the corresponding project by completing features 120 that are part of the project execution plan.

System 300 is further configured to display the project execution plans to a user of the system 300, ranked according to the project execution value of the project execution plans (block 1020).

As a non-limiting example, the user of the system 300 is a project manager of the corresponding project and the ranking of the project execution plans may be used as a decision support tool for the project manager when choosing the project execution plan to employ or when choosing project features 120 that are prioritized and will be executed before the non-prioritized project features 120 or when choosing which project to prioritize above other projects within a project portfolio.

In a similar way, system 300 may rank project execution plans for a number of projects included in a project portfolio allowing a project portfolio manager to choose which project execution plan to employ for the projects in the project portfolio.

It is to be noted that, with reference to FIG. 10, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Attention is drawn to FIG. 11, showing a flowchart illustrating one example of a sequence of operations carried out for determining project execution plans budgets, in accordance with the presently disclosed subject matter.

As a possible embodiment of the described subject matter, the feature size may be expressed in feature size units. The size units may be functionality points, indicative of the amount of business functionality the corresponding feature (e.g. feature A 120-a, feature B 120-b, feature C 120-c, feature D 120-d, feature E 120-e, . . . , feature N 120-n) provides to a client of the project the corresponding feature (e.g. feature A 120-a, feature B 120-b, feature C 120-c, feature D 120-d, feature E 120-e, . . . , feature N 120-n) is associated with. The size units may be alternatively expresses in feature points, indicative of the difficulty level of a feature type, wherein the difficulty may be related to complexities, risks, and efforts involved in completion of the corresponding feature (e.g. feature A 120-a, feature B 120-b, feature C 120-c, feature D 120-d, feature E 120-e, . . . , feature N 120-n) from the client's perspective. The size units may be alternatively expressed in other scaling methods: Fibonacci sequences, “Small, Medium, Large” (known as “T-Shirt Sizing”), etc.

Each given team may be associated with a team cost per feature size unit. The team cost per feature size unit may be determined based on historical costs of the given team in a given time-period, divided by a number of feature size units the given team completed during the given time-period. As a non-limiting example, team X may have completed feature A 120-a and feature B 120-b during a given time-period. For this example, both feature A 120-a and feature B 120-b have feature size of 5 units. This totals the feature size units completed by team X during the given time-period to 10 size units. For this example, the cost of team X during the given time-period is 1,000 dollars. The team cost per feature size unit for team X will be 100 dollars per feature size unit (1,000 dollars divided by 10 size units).

According to certain examples of the presently disclosed subject matter, system 300 can be configured to perform a budget and earned value determination process 1100, e.g. utilizing budget module 350. It is to be noted that system 300 performs the budget and earned value determination process 1100 after preforming the project planning process 400, as detailed above, inter alia, with respect to FIG. 4.

For this purpose, system 300 can be configured to determine a project execution plan budget for each of the project execution plans, wherein the project execution plan budget is determined using the team cost per feature size (block 1110). This may be achieved by determining the costs of each of the features (e.g. feature A 120-a, feature B 120-b, feature C 120-c, feature D 120-d, feature E 120-e, . . . , feature N 120-n) associated with the project execution plan by multiplying the feature size by the corresponding team cost per feature size, giving raise to a feature cost, and summing the feature costs.

To continue the example of team X above, if a given project execution plan includes feature C 120-c and feature D 120-d, both associated with team X and both have feature size of 10 units, the budget for the given project execution plan will be: (100 dollars*10)+(100 dollars*10)=2,000 dollars.

It is to be noted that in prior art agile project management methodologies the budget of a project could not be determined due to the fact that in prior art agile project management methodologies the team usually plans ahead for the next few iterations only (e.g. for the next two to four iterations) and not for the entire duration of the project.

In addition, a factor may be used for the project execution plan budget determination, wherein the factor is inductive of overhead expenses of a given team (e.g. training, vacations, etc.).

System 300 may be further configured to determine an earned value score for a given project, based on to the project's features 120 size, cost and completion dates, wherein the earned value score is indicative of how much of the budget of a given project should have been spent, considering the number of features 120 completed as part of the project so far (block 1120). The earned value score may be determined based on: (a) the one or more project execution plans of the given project, (b) the respective project execution plan budgets of the given project, and (c) an historical project execution plan of the given project. The earned value score may be determined by comparing an historical project execution plan and the corresponding features 120 size and cost completed and budget spent with a current project execution plan of the same project and the corresponding features size completed and budget spent.

For example, for a given project P an historical project execution plan demonstrates that feature A 120-a and feature B 120-b with a total size of 100 size units have been completed and the budget spent up to that point was 1,000 dollars. A current project execution plan of project P may demonstrate that feature C 120-c with a total size of 50 size units have been additionally completed and that the budget spent up currently stands on 1,500 dollars. The earned value of completing feature C 120-c is, therefore, 500 dollars.

In addition, system 300 may be further configured to determine budget estimation to completion for a given project, based on the earned value determination.

It is to be noted that, with reference to FIG. 11, some of the blocks can be integrated into a consolidated block or can be broken down to a few blocks and/or other blocks may be added. It is to be further noted that some of the blocks are optional. Specifically, block 1110 may be performed without preforming block 1120. It should be also noted that whilst the flow diagram is described also with reference to the system elements that realizes them, this is by no means binding, and the blocks can be performed by elements other than those described herein.

FIG. 12 is a flowchart illustrating one example of a sequence of operations carried out for generating simulated project execution plans, in accordance with the presently disclosed subject matter.

In this embodiment, at least some of features 120 may be associated with corresponding priority scores. The priority scores may correspond to the order of execution the features 120 within the project execution plan (e.g. the earlier the feature completion date is—the higher its priority score is). A change in priority of a feature feature A 120-a, feature B 120-b, feature C 120-c, feature D 120-d, feature E 120-e, . . . , feature N 120-n) may be as easy as changing the order of execution of that feature (e.g. feature A 120-a, feature B 120-b, feature C 120-c, feature D 120-d, feature E 120-e, . . . , feature N 120-n). Priority may be inductive of the importance of certain features 120 to the client of a given project that the features 120 are associated with or to the manager of the given project.

The priority may be at the project portfolio level by giving a certain priority to at least to some features 120 associated with a given project within the project portfolio.

According to certain examples of the presently disclosed subject matter, system 300 can be configured to perform a simulation process 1200, e.g. utilizing simulation module 355. It is to be noted that system 300 performs the simulation process 1200 after preforming the project planning process 400, as detailed above, inter alia, with respect to FIG. 4.

For this purpose, system 300 can be configured to generate the one or more project execution plans, also based on priority scores (block 1210). These project execution plans will define an order of execution of the features 120 based on their respective priority scores.

System 300 may be further configured to generate simulated project execution plans using one or more modified priority scores (block 1220). This may allow a project manager of a given project to simulate what-if situations by modifying the priority scores of one or more features 120 and to generate simulated execution plans using the modified priority scores. The project manager may compare these simulated project execution plans using various parameters, such as budget, meeting project milestones' due-dates, etc. The simulation gives the project manager a tool to decide on the actual priority of the features 120 associated with the given project.

In a similar way, a project portfolio manager may modify the priority of at least some features 120 associated with a given project within the project portfolio and analyze the effect on the entire project portfolio.

System 300 may be further configured to generate simulated project execution plans for simulated projects including one or more additional features 120 or one or more removed features 120 of the features 120 (block 1230). This may support a project manager of a given project to simulate what-if situations by modifying the content of the given project and to generate simulated execution plans using the modified content. The project manager may compare these simulated project execution plans using various parameters, such as budget, meeting project milestones' due-dates, value to the client of the given project, etc. The simulation gives the project manager a tool to decide on the actual features 120 to be associated with the given project.

In addition, the simulation may be used by the project manager to analyze the implications of introducing un-planned additional features 120 into the project execution plan. These un-planned additional features 120 may represent new business matter that the project manager wants, or is required, to introduce as part of the project.

In addition, system 300 may recommend to the project manager which features 120 may be removed from the project execution plan with minimal effect on the client of the given project.

In addition, system 300 may determine the cost of delay in accordance to the given project milestones (e.g. milestone A 210-a, milestone B 210-b, . . . , milestone N 210-n) and a required budget for the given project. The cost of delay can be determined based on contractual penalties on late delivery of the given project milestones (e.g. milestone A 210-a, milestone B 210-b, . . . , milestone N 210-n).

It is to be noted that, with reference to FIG. 12, some of the blocks can be integrated into a consolidated block or can be broken down to a few blocks and/or other blocks may be added. Furthermore, in some cases, the blocks can be performed in a different order than described herein (for example, block 1230 can be performed before block 1220, etc.). It is to be further noted that some of the blocks are optional. Specifically, blocks 1220 and 1230 may be optional. It should be also noted that whilst the flow diagram is described also with reference to the system elements that realizes them, this is by no means binding, and the blocks can be performed by elements other than those described herein.

Turning to FIG. 13, there is shown a flowchart illustrating one example of a sequence of operations carried out for optimizing project execution plans, in accordance with the presently disclosed subject matter.

In an embodiment of the disclosed subject matter, at least one of the features 120 may be associated with one or more of the following additional parameters:

(a) business value score, indicative of the value a given feature (e.g. feature A 120-a, feature B 120-b, feature C 120-c, feature D 120-d, feature E 120-e, . . . , feature N 120-n) may have to the client of the given project, wherein the given feature (e.g. feature A 120-a, feature B 120-b, feature C 120-c, feature D 120-d, feature E 120-e, . . . , feature N 120-n) is associated with a given project.

(b) risk level, indicative of the risk associated with the given feature (e.g. feature A 120-a, feature B 120-b, feature C 120-c, feature D 120-d, feature E 120-e, . . . , feature N 120-n). The risk may be decided by a given team which the given feature (e.g. feature A 120-a, feature B 120-b, feature C 120-c, feature D 120-d, feature E 120-e, . . . , feature N 120-n) is associated with or by a project manager of a given project, which the given feature (e.g. feature A 120-a, feature B 120-b, feature C 120-c, feature D 120-d, feature E 120-e, . . . , feature N 120-n) is associated with. The risk level may alternatively be automatically determined based on the complexity of the development required for completing the feature (e.g. feature A 120-a, feature B 120-b, feature C 120-c, feature D 120-d, feature E 120-e, . . . , feature N 120-n), past experience with similar features 120 or other risk parameters.

(c) required resources, indicative of the amount and type of resources required to complete a given feature (e.g. feature A 120-a, feature B 120-b, feature C 120-c, feature D 120-d, feature E 120-e, . . . , feature N 120-n). Resources are the mix of professions required to complete the given feature (e.g. feature A 120-a, feature B 120-b, feature C 120-c, feature D 120-d, feature E 120-e, . . . , feature N 120-n). As a non-limiting example, feature A 120-a may require (for its completion): two development team members, two software testers and one product owner.

According to certain examples of the presently disclosed subject matter, system 300 can be configured to perform an optimization process 1300, e.g. utilizing optimization module 360. It is to be noted that system 300 performs the optimization process 1300 after preforming the project planning process 400, as detailed above, inter alia, with respect to FIG. 4.

For this purpose, system 300 can be configured to generate the one or more project execution plans, by optimizing the feature execution order of the at least one given project with respect to the additional parameters. The generated project execution plans may be optimized so that features 120 associated with a higher business value score will be performed before features 120 having lower business value score. The generated project execution plans may be optimized so that features 120 associated with a higher risk level will be performed before features 120 having lower business value score. The generated project execution plans may be optimized so that order of execution of the features 120 will be synchronized with resources available to an organization developing the projects (block 1310).

As a non-limiting example, an optimized project execution plan may set an order of execution, placing feature A 120-a before feature B 120-b because the risk level associated with feature A 120-a is higher than the risk level associated with feature B 120-b.

System 300 may be further configured to optimize the feature execution order is so that project execution plan budgets of the project execution plans are minimized (block 1320). The project execution plan budget may be determined by the respective project manager or by system 300 at detailed above, inter alia, FIG. 11.

System 300 may be further configured to optimize the feature execution order so that resources required for the project execution plans are minimized (block 1330).

System 300 may be further configured to optimize the feature execution order to minimize a cost of delay (block 1340). The cost of delay may be determined based on contractual penalties on late delivery of the respective project milestones (e.g. milestone A 210-a, milestone B 210-b, . . . , milestone N 210-n).

An example of an optimized project execution plan may set an order of execution, placing feature A 120-a before feature B 120-b because the cost of delay for feature A 120-a and for a given milestone (e.g. milestone A 210-a, milestone B 210-b, . . . , milestone N 210-n) that is associated with feature A 120-a is higher than the cost of delay associated with feature B 120-b and for a given milestone (e.g. milestone A 210-a, milestone B 210-b, . . . , milestone N 210-n) that is associated with feature B 120-b.

Additionally, system 300 may generate a number of project execution plans, each optimized to a different combination of the additional parameters of features 120.

In addition, a project portfolio manager may use optimization is a similar way to optimize a given project within the project portfolio or to optimize the entire project portfolio. This may support business decisions taken by the project manager and the project portfolio manager by allowing the managers to compare possible project execution plans and their implications.

It is to be noted that, with reference to FIG. 13, some of the blocks can be integrated into a consolidated block or can be broken down to a few blocks and/or other blocks may be added. Furthermore, in some cases, the blocks can be performed in a different order than described herein (for example, block 1330 can be performed before block 1320, etc.). It is to be further noted that some of the blocks are optional. It should be also noted that whilst the flow diagram is described also with reference to the system elements that realizes them, this is by no means binding, and the blocks can be performed by elements other than those described herein.

Attention is drawn to FIG. 14, showing a flowchart illustrating one example of a sequence of operations carried out for assigning features to teams, in accordance with the presently disclosed subject matter.

In this embodiment at least some of the features 120 may be associated with required resources. The required resources are indicative of the amount and type of resources required to complete a given feature (e.g. feature A 120-a, feature B 120-b, feature C 120-c, feature D 120-d, feature E 120-e, . . . , feature N 120-n). At least some of the teams may have team resources. The team resources are indicative of the amount and type of resources available to the team. As a non-limiting example, team X may have: four software development team members, two software testers, one hardware engineer, one scrum master and one product owner.

According to certain examples of the presently disclosed subject matter, system 300 can be configured to perform a team assignment process 1400, e.g. utilizing team allocation module 365. It is to be noted that system 300 performs the team assignment process 1400 after preforming the project planning process 400, as detailed above, inter alia, with respect to FIG. 4.

For this purpose, system 300 can be configured to assign the features 120 to the teams based on the feature's (e.g. feature A 120-a, feature B 120-b, feature C 120-c, feature D 120-d, feature E 120-e, . . . , feature N 120-n) required resources and the team's team resources (block 1410).

As a non-limiting example, feature A 120-a that may require a resource type of hardware engineer may be assigned to team X whose team resources include a hardware engineer.

System 300 may be further configured to assign the features 120 to the teams based on the team's history, wherein each team is associated with a team history indicative of past features 120 developed by the team (block 1420).

For example, team X has a team's history of developing features which include hardware engineering work, system 300 may assign to team X features 120 that include hardware engineering work.

It is to be noted that, with reference to FIG. 14, some of the blocks can be integrated into a consolidated block or can be broken down to a few blocks and/or other blocks may be added. Furthermore, in some cases, the blocks can be performed in a different order than described herein (for example, block 1420 can be performed before block 1410, etc.). It is to be further noted that some of the blocks are optional. It should be also noted that whilst the flow diagram is described also with reference to the system elements that realizes them, this is by no means binding, and the blocks can be performed by elements other than those described herein.

FIG. 15 is a flowchart illustrating one example of a sequence of operations carried out for recommending team structures, in accordance with the presently disclosed subject matter.

In an embodiment of the disclosed subject matter, each of the features 120 may be associated with a feature type. The feature type is indicative of the nature of the work required to be completed for the completion of the corresponding feature (e.g. feature A 120-a, feature B 120-b, feature C 120-c, feature D 120-d, feature E 120-e, . . . , feature N 120-n). As a non-limiting example, the feature type may be: software, hardware, integration, etc.

According to certain examples of the presently disclosed subject matter, system 300 can be configured to perform a team structure recommendation process 1500, e.g. utilizing a team allocation module 365. It is to be noted that system 300 performs team structure recommendation process 1500 after preforming the project planning process 400, as detailed above, inter alia, with respect to FIG. 4.

For this purpose, system 300 can be configured to recommend a team structure for one or more of the features 120 based on the feature type and on historical information of structures of teams experienced with completing historical features 120 of the feature type (block 1510).

An example may be, recommending a team structure that includes a hardware engineer for features 120 with feature type hardware.

It is to be noted that, with reference to FIG. 15, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for management of a plurality of projects developed by a plurality of teams, each project of the projects spans over a plurality of consecutive time-periods, and having a plurality of milestones defined by a client of the respective project, each milestone defining corresponding stages of the respective project, each milestone having a milestone due-date, the system comprising a processing resource configured to perform the following:
(A)obtain, for each given project of the projects, information of a plurality of features required for completion of the given project, the information provided by a user of the system via a user interface, wherein each feature of the features (a) provides, upon completion, a usable functionality that delivers business value to the client of the given project, (b) has a feature size, the feature size being indicative of a complexity of the feature, (c) is associated with a given team of the teams; and (d) is associated with a given milestone of the milestones of the given project, so that a feature completion date of the feature affects an ability to meet the milestone due-date of the given milestone;
(B) determine, for each of the features, a feature completion date, based on (i) the feature size, (ii) a velocity of the given team, wherein the velocity is indicative of the given team's capacity, and wherein the velocity is determined based on past performance of the given team, and (iii) the milestones of the projects;
(C) generate one or more project execution plans, defining an order of execution of the features, for the at least one given project based on the feature completion dates;
(D)receive, via the user interface, from the user of the system, an update to the feature completion date of one or more of the features; and
(E) upon the update affecting one or more of the milestones due-dates in one or more of the projects, repeat (B) to (C).

2. The system of claim 1, wherein at least one of the teams is a multidisciplinary team, having at least a first team member of a first discipline and at least a second team member of a second discipline other than the first discipline.

3. The system of claim 1, wherein the processing resource is further configured to generate, for at least one given team of the teams, one or more team execution plans, defining an order of execution of a plurality of team features, wherein the team features are features associated with the given team and wherein the order of execution is based on the team features completion dates.

4. The system of claim 1, wherein the processing resource is further configured to per the following for at least one given feature of the features:
obtain an indication of the update of the feature completion date of the given feature, giving rise to an updated feature completion date, wherein the feature completion date is before the milestone due-date of the given milestone with which the given feature is associated, and wherein the updated feature completion date is after the milestone due-date of the given milestone with which the given feature is associated;
provide an alert of the update to the user of the system; and
update, upon the feature completion date being updated, one or more other feature completion dates, that are on a critical path to the given milestone.

5. The system of claim 1, wherein the processing resource is further configured to generate simulated project execution plans for simulated projects including one or more additional features or one or more removed features of the features.

6. The system of claim 1, wherein at least one of the features is associated with one or more of the following additional parameters: (a) business value score, (b) risk level, and (c) required resources, and wherein the processing resource is further configured to perform the generate by optimizing the feature execution order of the at least one given project, so that at least one of the following occurs: (a) project execution plan budgets of the project execution plans are minimized, (b) resources required for the project execution plans are minimized, or (c) a cost of delay is minimized.

7. The system of claim 6, wherein at least one given team of the teams is associated with a team structure, being inductive of the resources available to the given team and wherein the feature execution order is optimized to best utilize the given team's resources.

8. The system of claim 1, wherein each feature is associated with required resources, each team has team resources, each team is associated with a team history indicative of past features developed by the team, and wherein the processing resource is further configured to assign the features to the teams based on the feature's required resources, the team's team resources and the team's history.

9. The system of claim 1, herein each of the features is associated with a feature type and wherein the processing resource is further configured to recommend a team structure for one or more of the features based on the feature type and on historical information of structures of teams experienced with completing historical features of the feature type.

10. A method for management of a plurality of projects developed by a plurality of teams, each project of the projects spans over a plurality of consecutive time-periods, and having a plurality of milestones defined by a client of the respective project, each milestone having a milestone due-date, the method comprising performing the following:
(A)obtaining, utilizing a processing resource, for each given project of the projects, information of a plurality of features required for completion of the given project, the information provided by a user of the system via a user interface, wherein each feature of the features (a) provides, upon completion, a usable functionality that delivers business value to the client of the given project, (b) has a feature size, the feature size being indicative of a complexity of the feature, (c) is associated with a given team of the teams; and (d) is associated with a given milestone of the milestones of the given project, so that a feature completion date of the feature affects an ability to meet the milestone due-date of the given milestone;
(B) determining, utilizing the processing resource, for each of the features, a feature completion date, based on: (i) the feature size, (ii) a velocity of the given team, wherein the velocity is indicative of the given team's capacity, and wherein the velocity is determined based on past performance of the given team, and (iii) the milestones of the projects;
(C) generating, utilizing the processing resource, one or more project execution plans, defining an order of execution of the features, for the at least one given project based on the feature completion dates;
(D) receiving, utilizing the processing resource, via the user interface, from the user of the system, an update to the feature completion date of one or more of the features; and
(E) upon the update affecting one or more of the milestones due-dates in one or more of the projects, repeating (B) to (C).

11. The method of claim 10, wherein at least one of the teams is a multidisciplinary team, having at least a first team member of a first discipline and at least a second team member of a second discipline other than the first discipline.

12. The method of claim 10, further comprising generating, utilizing the processing resource, for at least one given team of the teams, one or more team execution plans, defining an order of execution of a plurality of team features, wherein the team features are features associated with the given team and wherein the order of execution is based on the team features completion dates.

13. The method of claim 10, further comprising performing the following for at least one given feature of the features:
obtaining utilizing the processing resource, an indication of the update of the feature completion date of the given feature, giving rise to an updated feature completion date, wherein the feature completion date is before the milestone due-date of the given milestone with which the given feature is associated, and wherein the updated feature completion date is after the milestone due-date of the given milestone with which the given feature is associated;
providing, utilizing the processing resource, an alert of the update to the user of the system; and
updating, utilizing the processing resource, upon the feature completion date being updated, one or more other feature completion dates, that are on a critical path to the given milestone.

14. The method of claim 10, further comprising generating, utilizing the processing resource, simulated project execution plans for simulated projects including one or more additional features or one or more removed features of the features.

15. The method of claim 10, wherein at least one of the features is associated with one or more of the following additional parameters: (a) business value score, (b) risk level, and (c) required resources, and wherein the method further comprising performing the generating, utilizing the processing resource, by optimizing the feature execution order of the at least one given project, so that at least one of the following occurs: (a) project execution plan budgets of the project execution plans are minimized, (b) resources required for the project execution plans are minimized, or (c) a cost of delay is minimized.

16. The method of claim 15, wherein at least one given team of the teams is associated with a team structure, being inductive of the resources available to the given team and wherein the feature execution order is optimized to best utilize the given team's resources.

17. The method of claim 10, wherein each feature is associated with required resources, each team has team resources, each team is associated with a team history indicative of past features developed by the team, and wherein the method further comprising assigning, utilizing the processing resource, the features to the teams based on the feature's required resources, the team's team resources and the team's history.

18. The method of claim 10, wherein each of the features is associated with a feature type and wherein the method further comprising recommending, utilizing the processing resource, a team structure for one or more of the features based on the feature type and on historical information of structures of teams experienced with completing historical features of the feature type.

19. A non-transitory computer readable storage medium having computer readable program code embodied therewith, the computer readable program code, executable by at least one processor of a computer to perform a method for management of a plurality of projects developed by a one or more teams, each project of the projects spans over a plurality of consecutive time-periods, and having a plurality of milestones defined by a client of the respective project, each milestone having a milestone due-date, the method comprising performing the following:
(A)obtaining, utilizing a processing resource, for each given project of the projects, information of a plurality of features required for completion of the given project, the information provided by a user of the system via a user interface, wherein each feature of the features (a) provides, upon completion a usable functionality that delivers business value to the client of the given project, (b) has a feature size, the feature size being indicative of a complexity of the feature, (c) is associated with a given team of the teams; and (d) is associated with a given milestone of the milestones of the given project, so that a feature completion date of the feature affects an ability to meet the milestone due-date of the given milestone;
(B) determining, utilizing the processing resource, for each of the features, a feature completion date, based on: (i) the feature size, (ii) a velocity of the given team, wherein the velocity is indicative of the given team's capacity, and wherein the velocity is determined based on past performance of the given team, and (iii) the milestones of the projects;
(C) generating, utilizing the processing resource, one or more project execution plans, defining an order of execution of the features, for the at least one given project based on the feature completion dates;
(D)receiving, utilizing the processing resource, via the user interface, from the user of the system, an update to the feature completion date of one or more of the features; and
(E) upon the update affecting one or more of the milestones due-dates in one or more of the projects, repeating (B) to (C).
